(19) United States
(12) Patent Application Publication
(10) Pub. No.: US 2004/0208184 A1
(43) Pub. Date: Oct. 21, 2004

(54) Method of network address setting

(75) Inventors: Kunio Tanaka, Tokyo (JP); Norinaga Mutai, Minamitsuru-gun (JP)

Correspondence Address: STAAS & HALSEY LLP, SUITE 700, 1201 NEW YORK AVENUE, N.W., WASHINGTON, DC, 20005, US

(73) Assignee: FANUC LTD, Yamanashi (JP)

(21) Appl. No.: 10/792,743

(22) Filed: Mar. 5, 2004

(30) Foreign Application Priority Data
Mar. 12, 2003 (JP) 2003-066570

(51) Int. Cl. H04L 12/28; H04L 12/56

(52) U.S. Cl. 370/397

(57) ABSTRACT

Network address request data is transmitted in the order in which the power is applied to control devices, or by adding a device ID assigned with a simple input means. An information processing device has a power application order or a correspondence table between device IDs and network addresses and informs each control device of network address determined for the above each control device.

### BACKGROUND OF THE INVENTION

1. Field of the Invention

This invention relates to a method of network address setting in a system obtained by connecting a plurality of control devices over a network to an information processing device adapted to manage these control devices.

2. Description of the Related Art

The most basic network address setting method applicable to a case where connection between a plurality of control devices and an information processing device adapted to manage these control devices is established over a network is to perform network address assignment by a manual operation with a display and an input/output unit such as a keyboard that are connected for each control device, or alternatively, to perform the above network address assignment with a rotary switch or the like prepared in place of a general-purpose input/output unit.

Specifically, when Ethernet (a registered trademark) is applied to the above connection, automatic assignment of an IP address specified as a network address of the Ethernet also takes place using a DHCP (Dynamic Host Configuration Protocol) available as one of Ethernet functions.

In addition, a technology is well known in which a plurality of combinations of IP address of client device and computer name are stored in advance in the form of a table in a server device, and the server device sends an unused one of the stored combinations of IP address and computer name to a client device when receiving an assignment information request by the client device at a startup time of the client device so that assignment is carried out (See Japanese Patent Application Laid-open No. 2002-300166).

In addition, another technology is also well known in which when an ARP (Address Resolution Protocol) request packet with a simultaneous broadcast address assigned is transmitted from a host device to terminals, each terminal sends a physical address and an IP address to the host device, and the host device sends the IP address to the terminal when the physical address and the IP address of each terminal are already on record, but the host device registers an unused IP address in association with the physical address when they are not on record, so that the IP address is assigned and sent to the terminal (See Japanese Patent Application Laid-open No. 8-237285).

In addition, a still another technology is also well known in which an ARP request packet is transmitted from a server to client devices after recording the same IP address to the client devices, and the client device transmits time data of receipt of the packet to the server. (See Japanese Patent Application Laid-open No. 11-74915).

Network address assignment with the input/output unit connected for each control device requires hardware of the display and the general-purpose input/output unit such as the keyboard, leading to an increase in cost for the control devices applicable to numerical control devices, robot control devices and PLCs (Programmable Logic Controller). In addition, setup of the general-purpose input/output unit is liable to take much time. Network address assignment with the rotary switch also requires as many as switches enough to attain the network address setting. For the IP address of the Ethernet, for instance, eight pieces of switches are required. A method of fixing high-order bits of an IP address in a condition where setting of several bits of low-order bits thereof is performed with the rotary switch or the like provides a semi-fixed IP address, so that application of the above method is limited to a closed network having limitations on the number of devices connected thereto.

Application of the Ethernet to the above connection is effective in allowing the DHCP server to perform automatic assignment of the IP address using the DHCP functions, while it is difficult to allow the above server to assign a specific IP address to each control device. A DHCP/DNS (Domain Name System) server obtained by linkage of the DHCP with a DNS server may perform assignment of the specific IP address to each specific control device name, while it is necessary to assign control device names to the control devices in advance. In addition, a special knowledge about networks is also required to work the DHCP/DNS server.

### SUMMARY OF THE INVENTION

The present invention relates to a method of network address setting by assigning network addresses to a plurality of control devices, such as numerical control devices, robot control devices and PLCs, respectively in a system obtained by connecting the plurality of control devices over a network to an information processing device adapted to manage the plurality of control devices.

A first mode of a method of network address setting according to the present invention comprises: transmitting a network address request from each control device to the information processing device; and causing the information processing device to inform each control device of network address with reference to a correspondence table between the receipt order of network address requests and network addresses, based on the order of receipt of the network address requests from each control device.

A second mode of a method of network address setting according to the present invention comprises: assigning a device ID to each control device with a device ID setting means installed in the each control device to transmit a network address request, together with the assigned device ID, from the each control device to the information processing device; and causing the information processing device informs each control device of network address with reference to a correspondence table between device IDs and network addresses, together with the device ID received from the each control device.

A third mode of a method of network address setting according to the present invention comprises: assigning a device ID to each control device with a device ID setting means installed in the each control device; transmitting a network address request, together with the device ID assigned to each control device, from the each control device to the information processing device; and causing the information processing device informs each control device of network address information with reference to a correspondence table between device IDs and network addresses, together with the device ID received from the each control device.

In the above second and third modes, when the number of the device IDs which can be assigned to the control devices are limited, the information processing device may be provided with a plurality of the correspondence tables in an ordered form, and the method of network address setting may comprise: a first step of transmitting network address requests for the number of control devices which can be assigned device IDs at a time, among the control devices connected to the network, together with the respective device IDs; a second step in which the information processing device informs the control devices of network address according to the first correspondence table, in response to the network address requests in the first step; a third step of transmitting network address requests for the number of control devices which can be assigned device IDs at a time, among the remaining control devices, together with the respective device IDs; and a fourth step in which the information processing device informs the control devices of the network address according to the second correspondence table in response to the network address requests in the third step; and repetition of the above third and fourth steps to be executed until the network address is completely informed to all the control devices to which network addresses have to be assigned.

Alternatively, in the above second and third modes, when the number of the device IDs which can be assigned to the control devices are limited, the same device ID may be assigned to a plurality of control devices, and the information processing device may be provided with a plurality of the correspondence tables in an ordered form for the same device ID, whereby, upon receiving network address requests with the same device IDs, the information processing device informs the control devices being on record in the correspondence tables of network addresses, in the order of the correspondence tables, according to the order of receipt of the network address requests.

In the first to third modes, transmission of the network address request from each control device to the information processing device may take place with an operation for the each control device via an operator. Alternatively, the operation via the operator may be an operation of a button installed on each control device.

In the first to third modes, transmission of the network address request from each control device to the information processing device may take place automatically when the power is applied to the each control device.

In the first to third modes, one of the control devices on the network may be used in place of the information processing device by providing the control device with the correspondence table or tables.

According to the present invention, there is provided the method of assigning the network addresses to the control devices easily without preparing any assigning input/output unit for the control devices or alternatively, with the minimum amount of hardware.

### BRIEF DESCRIPTION OF THE DRAWINGS

The foregoing and other objects and features of the invention will be more apparent from the following description of preferred embodiments of the invention with reference to the accompanying drawings, in which:

FIG. 1 is a block diagram showing a system configuration of each embodiment according to the present invention;

FIG. 2 is a block diagram showing an essential part of a numerical control device available as a control device in each embodiment according to the present invention;

FIG. 3 is a block diagram showing an essential part of an information processing device of each embodiment according to the present invention;

FIG. 4 is a flow chart showing an operation process of a first embodiment according to the present invention;

FIG. 5 illustrates an operation in the first embodiment;

FIG. 6 illustrates a correspondence table for assignment of network addresses to control devices in the first embodiment;

FIG. 7 is a flow chart showing an operation process of a second embodiment according to the present invention;

FIG. 8 illustrates an operation in the second embodiment;

FIG. 9 illustrates a correspondence table between device IDs and network addresses in the second embodiment;

FIG. 10 illustrates an operation in a third embodiment according to the present invention; and

FIG. 11 illustrates a table showing device IDs and corresponding network addresses in the third embodiment.

### DETAILED DESCRIPTION OF THE EMBODIMENTS

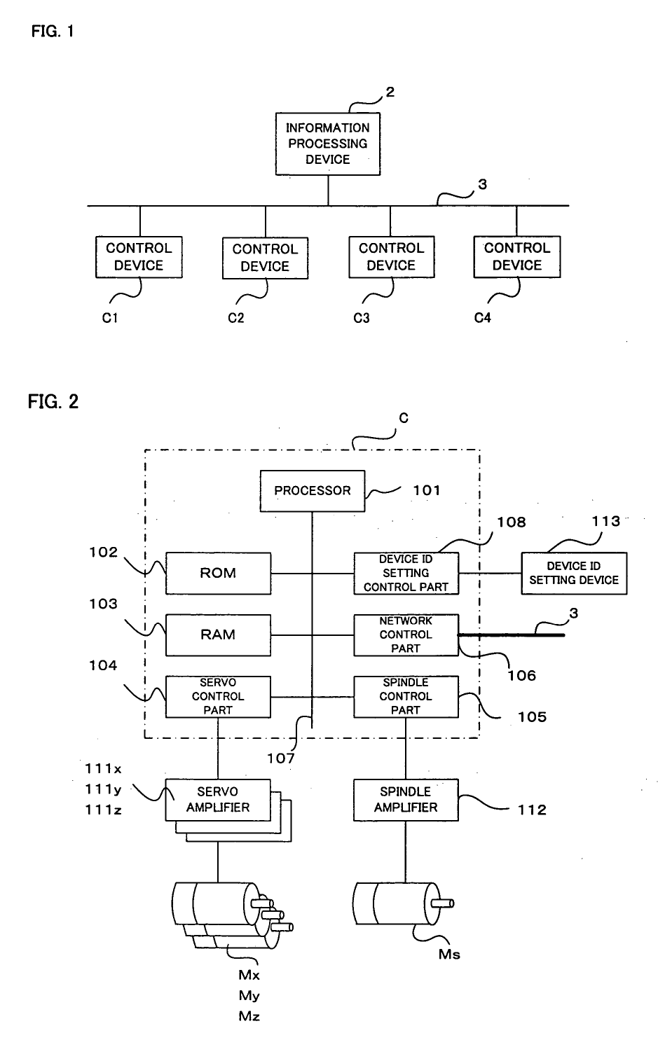

FIG. 1 is a block diagram showing a system configuration of one embodiment according to the present invention. In the above system configuration, a plurality of control devices C1, C2, C3, C4, . . . such as numerical control devices, robot control devices and PLCs are interconnected over a network 3. In addition, an information processing device 2 adapted to manage these control devices C1, C2, C3, C4, . . . is also connected to the network 3.

FIG. 2 is a block diagram showing an outline of a machine tool controlling numerical control device C (C1, C2, C3, C4, . . . ) as one of the control devices C1, C2, C3, C4, . . . , specifically, an essential part of the numerical control device C and that of a machine tool controlled with the above numerical control device C.

The numerical control device C has a processor 101 and components such as a ROM 102, a RAM 103, a servo control part 104, a spindle control part 105 and a network control part 106, which are all connected to the processor 101 through a bus 107. The processor 101 reads out a system program stored in the ROM 102 therefrom and controls the numerical control device C wholly according to the read system program. Temporary computational data is stored in the RAM 103. The servo control part 104 is composed of a processor and memories such as a ROM and a RAM and the like. The above servo control part 104 is adapted to drive axial servo motors Mx, My and Mz through axial servo amplifiers 111x, 111y and 111z in response to an instruction for movement to each feed axis (specifically, feed axes in the first embodiment are assumed to be those for orthogonal X, Y and Z axes) by the main processor 101 of the numerical control device C with reference to a machining program.

The above numerical control device C and the above machine tool are not different in basic configuration and operation from a conventional numerical control device and a conventional machine tool, except that the above numerical control device C does not have a display control part, a display and a keyboard that are all required for network address assignment. Instead, there are the following two cases applicable to the above numerical control device C in relation to the present invention, one case where the numerical control device C has a device ID setting control part 108 and a device ID setting device 113 such as a rotary switch, a button or like, hardware allowing easy input of a device ID, and the other case where neither the device ID setting control part 108 nor the device ID setting device 113 is required. In FIG. 2, there is shown the case where the numerical control device C has the device ID setting control part 108 and the device ID setting device 113. Further, the system program in relation to the present invention comprises a step of assigning a device ID, a step of transmitting a network address request to the information processing device 2 and a step of receiving network address information from the information processing device 2.

It is noted that a robot control device, a PLC or the like is equivalent to the numerical control device C. Thus, the present invention also involves network address assignment attained by adding the device ID setting control part 108 and the device ID setting device 113 to each conventional robot control device or each conventional PLC.

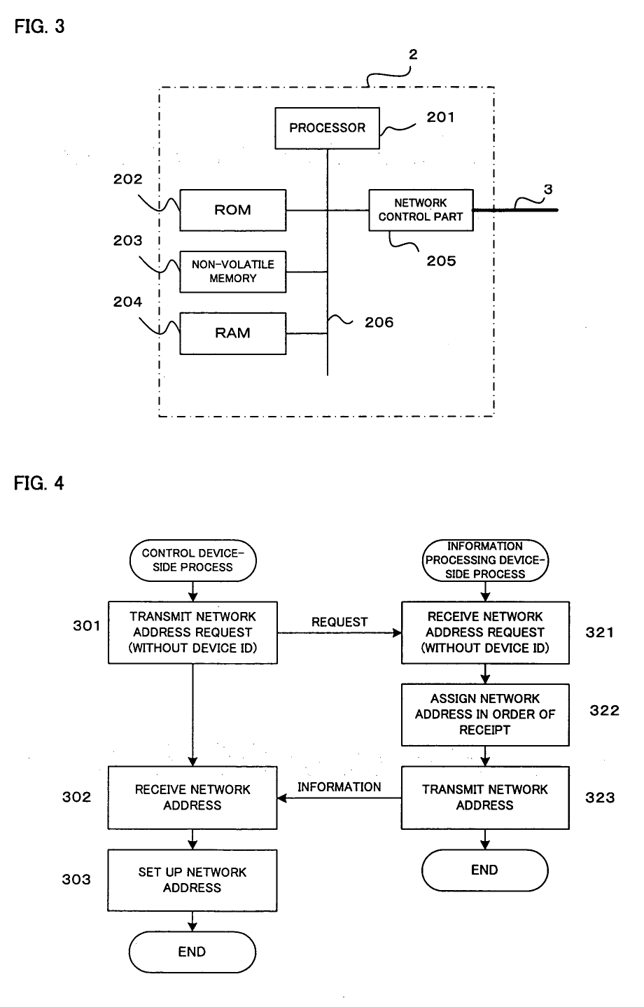

FIG. 3 is a block diagram showing an essential part of the information processing device 2 of one embodiment according to the present invention. The information processing device 2 has a processor 201 and components such as a ROM 202, a non-volatile memory 203 configured with an EEPROM, a RAM 204 and a network control part 205, which are all connected to the processor 201 through a bus 206. The processor 201 reads out a system program stored in the ROM 202 therefrom, so that the information processing device 2 works according to the read system program. The RAM 204 is used as a working memory applied to the above operation of the processor. In addition, the non-volatile memory 203 has a correspondence table, in which correspondences between the control devices C1, C2, C3, C4, . . . and the network addresses are stored. The system program stored in the ROM 202 comprises a step of receiving a network address request from each of the above control devices C1, C2, C3, C4, . . . , and a step of giving network address information to the relevant control device Cj with reference to the correspondence table between control devices (C1, C2, C3, C4, . . . ) and network addresses (as will be described later), in response to the above network address request.

It is noted that the information processing device 2 may be a typically available personal computer or the like having network functions. In this case, a hard disk storage device is generally specified as the ROM 202 and the non-volatile memory 203. Alternatively, one control device Cj, selected from among the control devices C1, C2, C3, C4, . . . , may play the role of an information processing device 2 by allowing the system program of the control device Cj to execute the above steps.

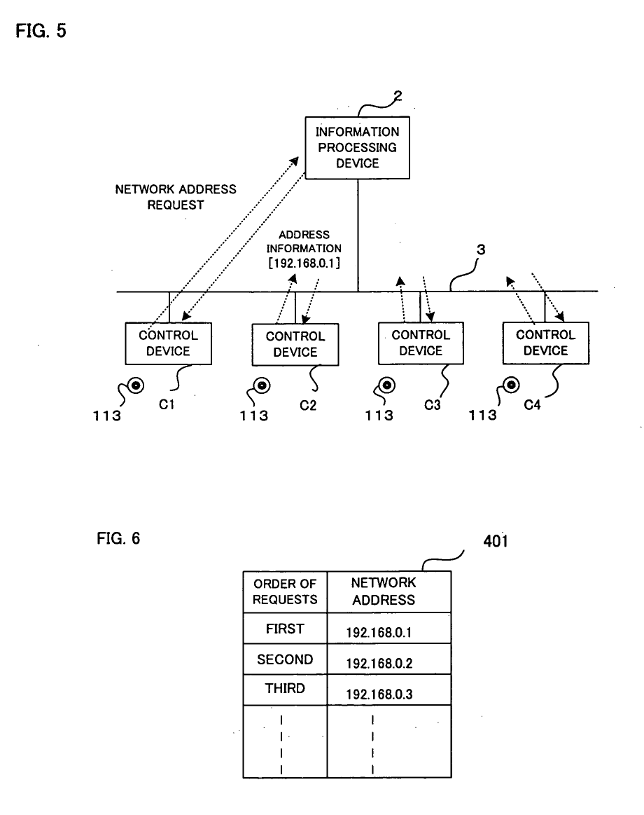

FIG. 4 is a flow chart showing a method of network address setting in the first embodiment according to the present invention. FIG. 5 illustrates an operation in the first embodiment. FIG. 6 illustrates a correspondence table 401 that is provided in the non-volatile memory 203 of the information processing device 2 in the first embodiment and in which the correspondences between the control devices C1, C2, C3, C4, . . . and the network addresses are stored.

In the first embodiment, each of the control devices (specifically, the numerical control devices) C1, C2, C3, C4, . . . has a network address request instructing button as the device ID setting device 113, having not an ID setting control part 108. Alternatively, it is not necessary for each control device to have such a button, if each control device is adapted to output a network address request signal automatically when the power is applied to the control devices C1, C2, C3, C4, . . . .

In the correspondence table 401, the network addresses are set up and stored in order so as to correspond to the order of network address requests.

The system program of each control device C1, C2, C3, C4, . . . transmits a network address request through the network control part 106 to the network 3 in a simultaneous broadcast manner by an operation of the button or the like via the operator or automatically when the power is applied (Step 301). Transmission in the simultaneous broadcast manner causes data to be transmitted to all the devices connected to the network 3, so that the control devices C1, C2, C3, C4, . . . need not get a network address of the information processing device 2 for transmitting the network address requests to the information processing device 2.

The system program of the information processing device 2 reads the network address request received through the network control part 205 over the network (Step 321). Then, the system program determines the network address with reference to the correspondence table 401 between network address request orders and network addresses (Step 322). Specifically, the information processing device 2 reads out the network address from the correspondence table 401 and sets up the read network address on the control device Cj that has issued the network address request, in the order of receipt of the network address requests. Subsequently, the system program transmits network address information through the network control part 205 to the network 3 (Step 323). As the information processing device 2 transmits the network address in response to the earlier received network address request, the network address information is can be transmitted although network addresses are not assigned to the control devices C1, C2. C3, C4, . . . at this point of time.

The system program of each control device C1, C2, C3, C4, . . . reads the network address information received through the network control part 106 over the network 3 (Step 302). Subsequently, the system program sets up the received network address on the network control part 106 (Step 303), thereafter, the network control part 106 can deal with data corresponding to the network address set up thereon, as data addressed to one's own device.

As described above, as network addresses are assigned to the control devices C1, C2, C3, C4, . . . in the order of transmission of network address requests, an operator can understand the network addresses assigned to the control devices C1, C2, C3, C4, . . . , regardless of automatic assignment of the network addresses. Consequently, the system and the operator can share the same understanding.

In FIG. 5, there is shown a case where the control device C1 outputs a first network address request, the information processing device 2 determines a network address “192.168.0.1” corresponding to the first receipt of the network address request with reference to the correspondence table 401 and then transmits the determined network address to the control device C1, with the result that the network address “192.168.0.1” is assigned to the control device C1.

A plurality of control devices execute processing at steps 301, 302 and 303 so that non-duplicate network addresses can be assigned to all the control devices.

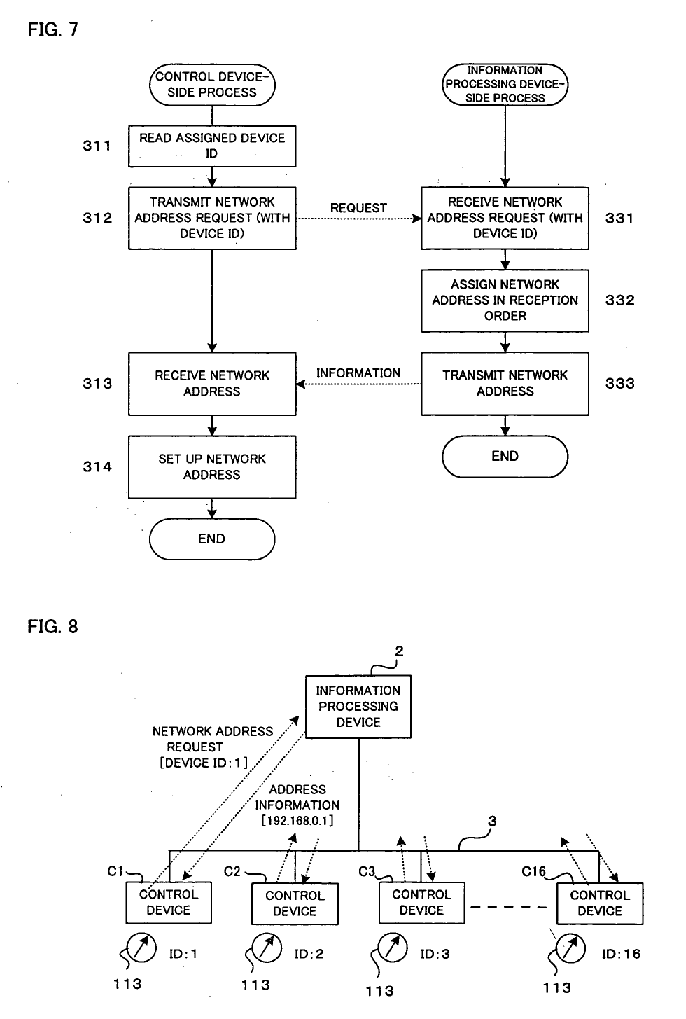

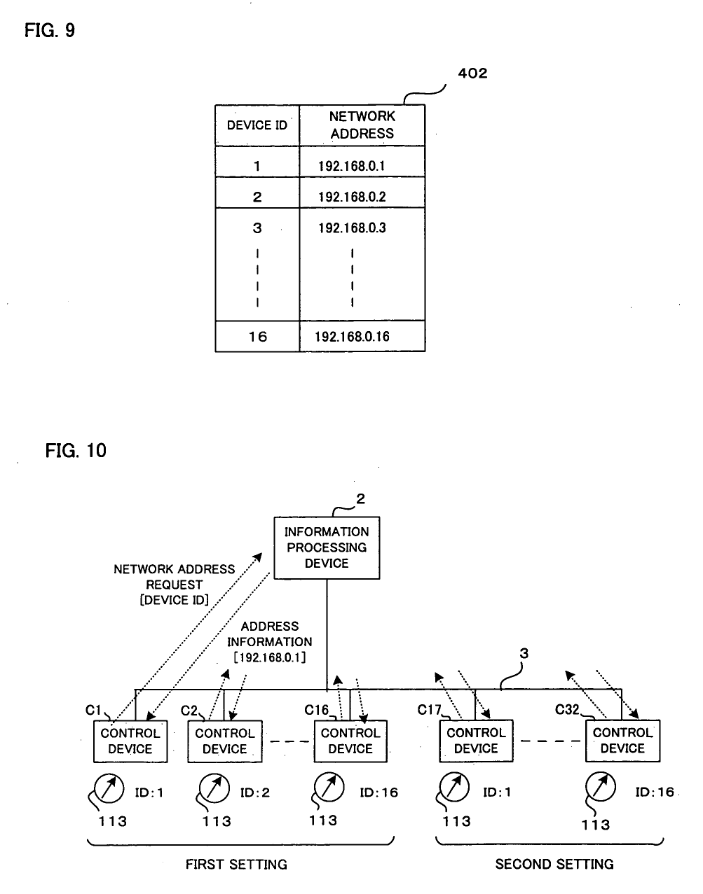

FIG. 7 is a flow chart showing the method of network address setting in a second embodiment according to the present invention. FIG. 8 illustrates an operation in the second embodiment. FIG. 9 illustrates a correspondence table 402 that is provided in the non-volatile memory 203 of the information processing device 2 in the second embodiment and in which correspondences between the control devices C1, C2, C3, C4, . . . and the network addresses are stored. As shown in FIG. 9, in the correspondence table 402 in the second embodiment, the network addresses are set up and stored in correspondence to the device IDs.

In the second embodiment, each of the control devices C1, C2, C3, C4, . . . has the device ID setting device 113 such as the rotary switch, as shown in FIG. 8. When a network address request instruction is inputted to the control device Cj after an ID is set in the device ID setting device 113, the system program reads the device ID in the device ID setting device 113 with the device ID setting control part 108 (Step 311), and then network address request with the device ID attached is transmitted through the network control part 106 to the network 3 in the simultaneous broadcast manner (Step 312).

When the system program of the information processing device 2 reads the network address request received through the network control part 205 over the network 3 (Step 331), it determines the network address set up and stored for the control device Cj having the received device ID, with reference to correspondence table 402 between device IDs and network addresses (See FIG. 9) (Step 332). Subsequently, network address information is transmitted through the network control part 205 to the network 3 in response to the network address request (Step 333).

The system program of each control device C1, C2, C3, C4, . . . then reads the network address information received through the network control part 106 over the network 3 (Step 313), and sets up the received network address in the network control part 106. Thereafter, the network control part 106 can deal with data corresponding to the network address set up thereon, as data addressed to one's own device. As a plurality of control devices C1, C2, C3, C4, . . . execute processing at steps 311, 312, 313 and 314, non-duplicate network addresses can be assigned to all the control devices C1, C2, C3, C4, . . . . Specifically, network address requests may be transmitted to the information processing device 2 every time device IDs are assigned to the control devices C1, C2, C3, C4, . . . , or after device IDs are assigned to all the control devices C1, C2, C3, C4, . . . .

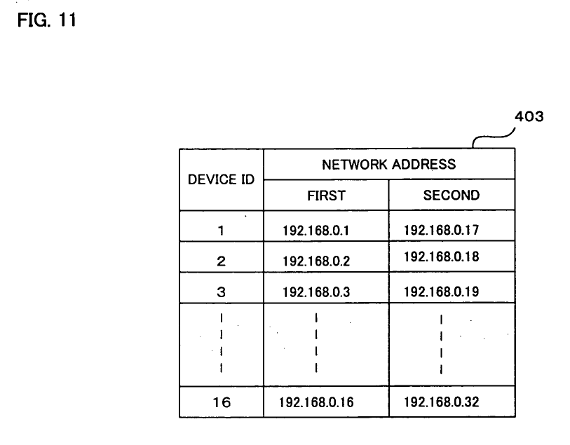

FIGS. 10 and 11 illustrate a third embodiment according to the present invention. In a case of the third embodiment, the number of IDs which can be set by means of the device ID setting device 113 composed of a rotary switch or the like is limited and the number of the control devices C1, C2, C3, C4, . . . connected to the network is larger than that of the IDs which can be assigned with the device ID setting device 113. Specifically, in a case of the third embodiment, 16 device IDs can be assigned with the device ID setting device 113 and 32 control devices C1, C2, C3, C4, . . . C32 are connected over the network 3.

In the correspondence table 403 between device IDs and network addresses (See FIG. 11), first and second network addresses are assigned and stored for the device IDs “1” to “16”.

In case of the third embodiment, network address requests can be carried out and processed every number of control devices which can be assigned device IDs by means of the device ID setting device 113. Specifically, non-duplicate network addresses can be assigned to all the control devices with a first step of transmitting network address requests for the number of control devices which can be assigned device IDs at a time, among the control devices connected to the network, together with the respective device IDs; a second step in which the information processing device informs the control devices of network address according to the first correspondence table, in response to the network address requests in the first step; a third step of transmitting network address requests for the number of control devices which can be assigned device IDs at a time, among the remaining control devices, together with the respective device IDs; and a fourth step in which the information processing device informs the control devices of the network address according to the second correspondence table in response to the network address requests in the third step; and repetition of the above third and fourth steps to be executed until the network address is completely informed to all the control devices to which network addresses have to be assigned.

The information processing device 2 first receives network address requests as many as the device IDs set up and stored in the correspondence table 403, and transmits the network addresses for the received IDs to the control devices C1 to C16. Then, the information processing device 2 judges the network address requests to be received next is second one, and then transmits the network address set up as the second one corresponding to the received device IDs. After network address requests as many as the device IDs set up as the second one are received and the network address are transmitted to the control devices, a processing is carried out as the third one.

As described above, the relation between the control devices C1, C2, C3, C4, . . . C32 and the set-up network addresses becomes clear to an operator by performing network address requests in unit of control devices which can be set by means of the device ID setting device such as the rotary switch.

Network addresses can be set to the control devices, even if network address requests are not outputted in groups for each unit of the number which can be assigned by means of the device ID setting device 113 as described above (specifically, for each unit of number of device IDs set up in the correspondence table 403). In this case, a counter or the like is provided to the information processing device 2 for each device ID. The value of the counter is incremented after transmission of a network address in response to the network address request of the corresponding ID. With the value of the counter, the discriminated address can be assigned and transmitted to the control device having the same device IDs. Accordingly, even if the network address requests successively are outputted from the two control devices with the device. ID “1” assigned (specifically, the control devices C1 and C17 in the embodiment shown in FIG. 10), respectively, for instance, the first network address (“192,168.0.1” in the embodiment shown in FIG. 10) is assigned to the control device that has earlier transmitted the network address request, while the second network address (“192.168.0.17” in the embodiment shown in FIG. 10) is assigned to the control device that has outputted the next network address request.

In this case, however, among the control devices with the same device ID assigned by means of the device ID setting device 113, if the order of network addresses requests differs, then the network address request to be assigned differs. Thus, it is necessary to clearly establish the order of network address requests in advance by some means so as to inform an operator of the correct network addresses assigned to the control devices.

In the above embodiments, the information processing device 2 adapted to control the control devices C1, C2, C3, C4, . . . is provided, in addition to the control devices. Alternatively, one control device Cj, selected from among the control devices C1, C2, C3, C4, . . . , may be used in place of the information processing device 2 in such a manner as to allow the above one control device to execute the similar functions to those of the information processing device 2.

The present invention is effective in assigning the specific network addresses to the plurality of networked control devices with a simple operation in case of network setting for the control devices such as NCs, robots and PLCs without requiring redundant hardware such as the display and the keyboard. It is possible to assign the specific network addresses to the control devices in conformity with the network to be connected, so that connection to the existing network is easily established.

1. A method of network address setting by assigning network addresses to a plurality of control devices respectively in a system obtained by connecting said plurality of control devices over a network to an information processing device adapted to manage said plurality of control devices, comprising:
transmitting a network address request from each control device to said information processing device; and
causing said information processing device to inform each control device of network address with reference to a correspondence table between the receipt order of network address requests and network addresses, based on the order of receipt of the network address requests from each control device.

2. A method of network address setting by assigning network addresses to a plurality of control devices respectively in a system obtained by connecting said plurality of control devices over a network to an information processing device adapted to manage said plurality of control devices, comprising:
assigning a device ID to each control device with a device ID setting means installed in said each control device to transmit a network address request, together with said assigned device ID, from said each control device to said information processing device; and
causing said information processing device informs each control device of network address with reference to a correspondence table between device IDs and network addresses, together with the device ID received from said each control device.

3. A method of network address setting by assigning network addresses to a plurality of control devices respectively in a system obtained by connecting said plurality of control devices over a network to an information processing device adapted to manage said plurality of control devices, comprising:
assigning a device ID to each control device with a device ID setting means installed in said each control device;
transmitting a network address request, together with said device ID assigned to each control device, from said each control device to said information processing device; and
causing said information processing device informs each control device of network address information with reference to a correspondence table between device IDs and network addresses, together with the device ID received from said each control device.

4. The method of network address setting according to claim 2, wherein the number of the device IDs which can be assigned to the control devices are limited and said information processing device is provided with a plurality of said correspondence tables in an ordered form, comprising,
a first step of transmitting network address requests for the number of control devices which can be assigned device IDs at a time, among the control devices connected to the network, together with the respective device IDs;
a second step in which the information processing device informs the control devices of network address according to the first correspondence table, in response to the network address requests in the first step;
a third step of transmitting network address requests for the number of control devices which can be assigned device IDs at a time, among the remaining control devices, together with the respective device IDs; and
a fourth step in which the information processing device informs the control devices of the network address according to the second correspondence table in response to the network address requests in the third step;
and repetition of the above third and fourth steps to be executed until the network address is completely informed to all the control devices to which network addresses have to be assigned.

5. The method of network address setting according to claim 2, wherein the number of the device IDs which can be assigned to the control devices are limited, the same device ID is assigned to a plurality of control devices, and said information processing device is provided with a plurality of said correspondence tables in an ordered form for the same device ID, whereby, upon receiving network address requests with the same device IDs, said information processing device informs said control devices being on record in said correspondence tables of network addresses, in the order of said correspondence tables, according to the order of receipt of said network address requests.

6. The method of network address setting according to claim 1, wherein transmission of said network address request from each control device to said information processing device takes place with an operation for said each control device via an operator.

7. The method of network address setting according to claim 6, wherein said operation via the operator is an operation of a button installed on each control device.

8. The method of network address setting according to claim 1, wherein transmission of said network address request from each control device to said information processing device takes place automatically when the power is applied to said each control device.

9. The method of network address setting according to claim 1, wherein one of the control devices on the network is used in place of said information processing device by providing the control device with said correspondence table or tables.

10. The method of network address setting according to claim 1, wherein said control devices are any of numerical control devices, robot control devices and PLCs.

11. A system obtained by connecting a plurality of control devices to a single information processing device through a bus and being adaptable for network address assignment, wherein
each of said control devices comprises;
device ID setting means for assigning an ID to each of the control device, and
transmitting means for transmitting a network address request toward said bus, and
said information processing device comprises;
a memory in which correspondences between control device IDs assigned with said device ID setting means and network addresses are stored in the form of a correspondence table, and
an informing means for informing each control device of network addresses with reference to said correspondence table, based on the device ID received from said each control device.
